(19) United States
(12) Patent Application Publication
(10) Pub. No.: US 2025/0124401 A1
(43) Pub. Date: Apr. 17, 2025

(54) DECLARATIVE INSTANTANEOUS INVENTORY COLLECTION

(71) Applicant: DELL PRODUCTS L.P., Round Rock, TX (US)

(72) Inventors: Parmeshwr Prasad, Bangalore (IN); Raveendra Babu Madala, Bangalore (IN)

(21) Appl. No.: 18/487,579

(22) Filed: Oct. 16, 2023

(51) Int. Cl. G06Q 10/087

(52) U.S. Cl. CPC G06Q 10/087

(57) ABSTRACT

An inventory system is provided for inventorying inventory items on a plurality of information handling systems. The inventory system includes the plurality of information handling systems and an inventory manager. Each information handling system includes a plurality of inventory items. The inventory manager manages an inventory object, and collects an inventory of the inventory items based on the inventory object. The inventory object identifies inventory information related to the inventory items that are to be collected in the inventory, and identifies execution information related to the collection of the inventory.

### FIELD OF THE DISCLOSURE

This disclosure generally relates to information handling systems, and more particularly relates to instantaneous inventory collection in a network of information handling systems.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, reservations, enterprise data storage, or global communications. In addition, information handling systems may include a variety of hardware and software resources that may be configured to process, store, and communicate information and may include one or more computer systems, data storage systems, and networking systems.

### SUMMARY

An inventory system may be provided that includes information handling systems and an inventory manager. Each information handling system may include inventory items. The inventory manager may manage an inventory object, and collect an inventory of the inventory items based on the inventory object. The inventory object may identify inventory information related to the inventory items that are to be collected in the inventory, and identify execution information related to the collection of the inventory.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram of an inventory network according to an embodiment of the current disclosure;

FIG. 2 is a flowchart illustrating a method for providing a declarative instantaneous inventory collection on an inventory network according to an embodiment of the current disclosure;

FIG. 3 is a flowchart illustrating a method for processing an instantaneous inventory collection on an inventory network according to an embodiment of the current disclosure;

FIG. 4 is a flowchart illustrating a method for validating an inventory of an inventory network according to an embodiment of the current disclosure; and

FIG. 5 is a block diagram illustrating a generalized information handling system according to another embodiment of the present disclosure.

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings, and should not be interpreted as a limitation on the scope or applicability of the teachings. However, other teachings can certainly be used in this application. The teachings can also be used in other applications, and with several different types of architectures, such as distributed computing architectures, client/server architectures, or middleware server architectures and associated resources.

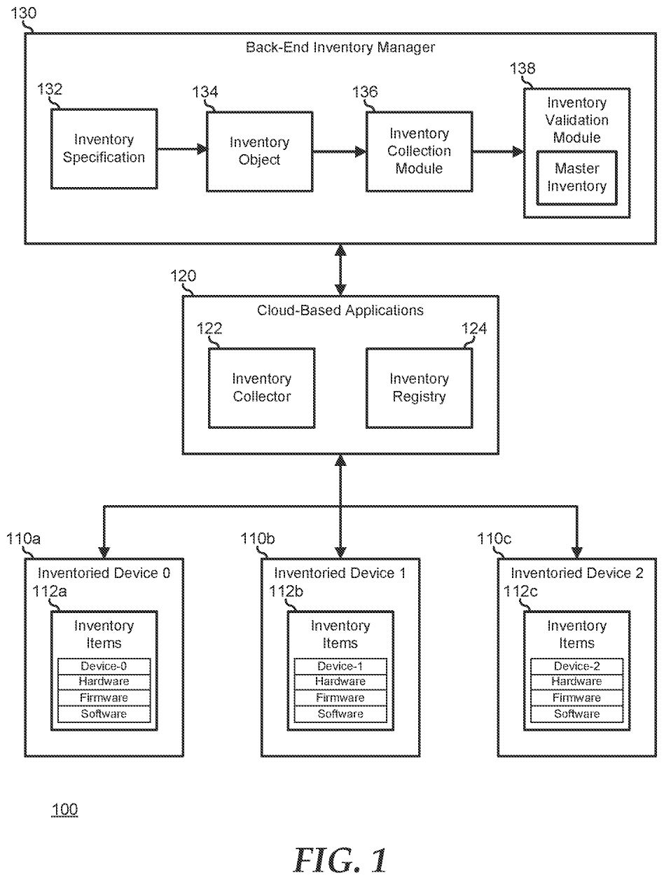

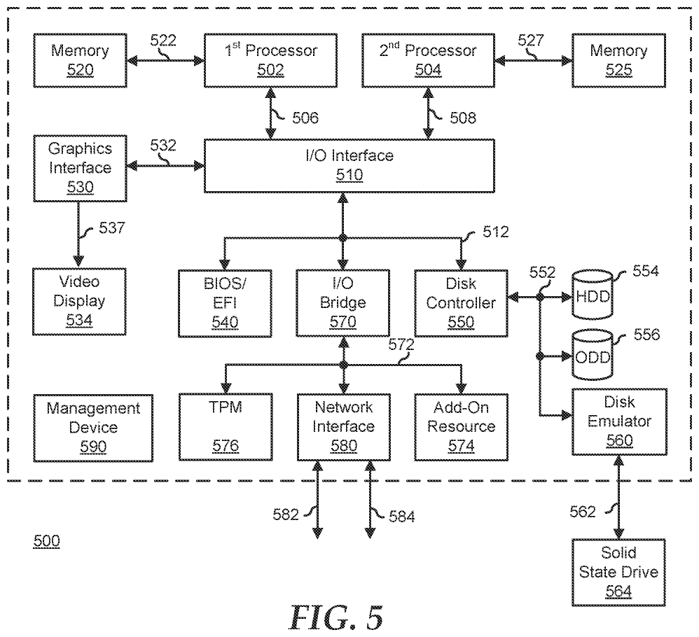

FIG. 1 illustrates an inventory network 100 including an inventoried device-0 110a, an inventoried device-1 110b, an inventoried device-2 110c, cloud-based applications 120, and a back-end inventory manager 130. Inventoried device-0 includes inventory items 112a, inventoried device-1 includes inventory items 112b, and inventoried device-2 includes inventory items 112c. Inventoried device-0 110a, inventoried device-1 110b, and inventoried device-2 110c may be referred to collectively as inventoried devices 110, and inventory items 112a, 112b, and 112c may be referred to collectively as inventory items 112. Examples of inventoried devices 110 may include information handling systems such as information handling system 500 as shown in FIG. 5 and described below, other types of network-connected devices such as printers, projectors, Internet-of-Things (IoT) devices, datacenter devices such as servers, blade- or chassis-based systems, routers, switches, storage devices, network devices, or the like, or other devices as needed or desired.

In particular, inventoried devices 110 represent devices that operate to provide inventory information for themselves, either through a resident service or utility that determines the inventory information, or through a remote service or utility that queries the inventoried devices for the inventory information. Thus, a device that needs visual or physical observation to determine the inventory information would not typically be understood to represent an inventoried device for the purposes of the current disclosure. In this regard, inventoried devices 110 are connected to cloud-based applications 120 via one or more data communication network, such as an Ethernet network, a FibreChannel network, a wireless data communication network, another data communication network, or a combination thereof. Inventoried devices 110 are illustrated as being on a common connection to cloud-based applications 120, and being on a single hierarchical level, but this is not necessarily so, and the inventoried devices may be connected to the cloud-based applications by multiple connections, and may themselves be arranged in a multi-tiered network of devices as needed or desired.

Inventory items 112 represent the elements of the respective inventoried devices that can be separately described and cataloged in an inventory, such as a database or the like. As such, inventory items 112 are illustrated as including the associated inventoried device 110, the hardware elements of the inventoried device, the firmware elements of the associated inventoried device, and the software elements instantiated on the associated inventoried device. For example, the hardware elements of inventoried devices 110 may include any installed item such as processors, memory devices, add-in cards or modules, daughter cards, riser cards, data storage devices, input/output (I/O) devices such as network interface cards (NICs), host bus adaptors (HBAs), storage adaptors, or the like, power supplies, thermal management devices such as cooling fans or liquid cooling modules, or other hardware elements of the inventoried devices as needed or desired. An example of a firmware element of inventoried devices 110 may include a basic input/output system (BIOS) or Universal Extensible Firmware Interface (UEFI), device or interface firmware, core operating services or utilities, or the like. An example of a software element instantiated on inventoried devices 110 may include host operating software such as an operating system (OS), a virtual machine manager (VMM) or hypervisor, or the like, and software applications, programs, utilities, services or the like that are instantiated within the host operating software, or other software instantiated on the inventoried devices, as needed or desired.

Cloud-based applications 120 include an inventory collector 122 and an inventory registry 124. Inventory collector 122 represents a service or utility that queries inventoried devices 110 to obtain inventory information related to inventory items 112. In a particular embodiment, inventoried devices 110 include native services or utilities that collect the inventory information from respective inventoried items 112, and inventory collector 122 operates to query the inventoried devices to obtain the inventory information. In another embodiment, inventory collector 122 operates to perform an inventory search on inventoried devices 110 to obtain the desired inventory information. In either embodiment, inventory collector 122 receives the inventory information and stores the inventory information for all of inventoried devices 110 to inventory registry 124.

The contents of inventory registry 124 may vary depending upon the needs or desires of a user or administrator of inventory network 100. In particular, the contents of inventory registry 124 may or may not include all of inventor items 112, depending on how the inventory registry is to be utilized. For example, where inventory network 100 represents a datacenter environment, various entities within the datacenter management team may desire to monitor and track the inventory status of different elements of inventory items 112. Thus a management team tasked with managing the physical assets of the datacenter may desire inventory registry 124 to include only inventory information related to the hardware elements, or may desire the inventory registry to only include the power and cooling related hardware elements, or other subsets of the hardware elements, as needed or desired. On the other hand, a management team tasked with the management of the compute environment of the datacenter may desire inventory registry 124 to include compute hardware and the associated firmware, or may desire the inventory registry to only include the firmware elements for the purposes of maintaining the firmware in an updated state. In another case, a client-oriented team may desire inventory registry 124 to include only virtual machines instantiated on inventoried devices 110, the firmware elements instantiated on the virtual machines, and the associated software elements. Thus inventory registry 124 may represent multiple iterations of the inventory registry, and inventory items 112 may include virtual items as needed or desired.

Back-end inventory manager 130 represents an interface with which a user or administrator on inventor network 100 directs the collection of inventory information from inventoried devices 110. Back-end inventory manager 130 includes an inventory specification 132, an inventor object 134, an inventory collection module 136, and an inventory validation module 138. Inventory specification 132 represents a collection of the inventory information to be automated, validated, and protected with a permission structure based on parameters specified in the template. In particular, the user or administrator utilizes inventory specification 132 to create inventory object 134 to define the target inventoried devices 110. Target information may include a host or baseboard management controller IP address, log-in credentials, an identification of the inventory collection module to be used (that is, inventory collector 122 or an inventory module native to the particular inventoried device 110), information identifying inventory registry 124 or another inventory registry, whether the inventoried device is part of cluster or a remote setup.

Inventory specification 132 also defines the type of inventory items 112 to be collected. For example, the type information may include any set of items within items 112 as needed or desired. Finally, inventory specification 132 includes information to automate the inventory collection process, such as inventory collection frequency information, time-of-day or day-of-the-week information, inventory triggering events, such as detected change in inventory items 112, or the like. Inventory specification 132 may be stored in any format as needed or desired, such as in a JavaScript Object Notation (JSON) file, a YAML, file, or the like.

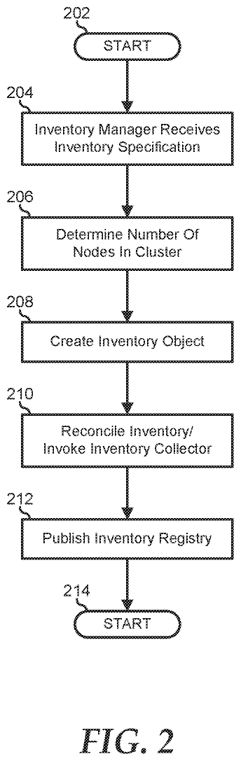

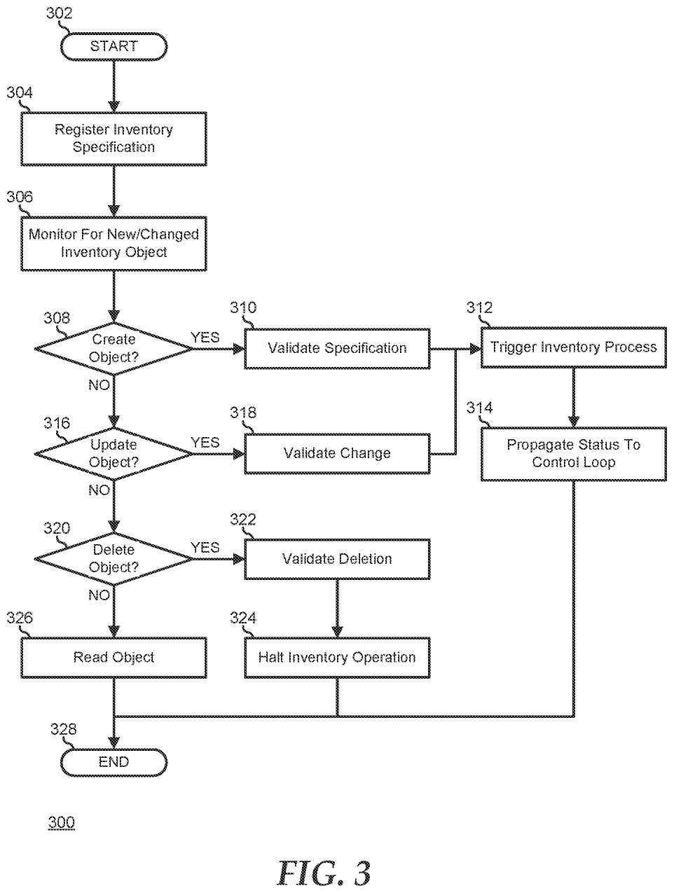

After inventory object 134 is created, the inventory object is registered to cloud-based applications 120 in preparation for collecting the inventory information. The creation of inventory object 134 triggers the collection of the inventory information in accordance with the inventory object, as described further below. In particular, once inventory object 134 is created, inventory collection module 136 is triggered to collect the inventory information in accordance with inventory specification 132. In a particular embodiment, inventory collection module 136 operates to refer to inventory object 134, and to direct inventory collector 122 to collect the designated inventory items for storage to inventory registry 124. In another embodiment, inventory collection module 136 directs inventory collector 122 to collect the inventory information in accordance with inventory object 134, and the inventory collector collects the inventory information in accordance with the inventory object as instantiated on cloud-based applications 120 for storage to inventory registry 124. A method for the collection of inventory information as described herein is further shown in FIG. 2, below. The collection of the inventory information as described herein may be performed in response to the creation, update, deletion, or read of inventory object 134, as further shown in FIG. 3, below.

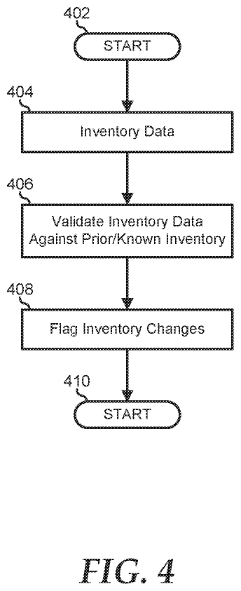

After the inventory information is stored to inventory registry 124, inventory collection module 136 operates to invoke inventory validation module 138 to validate the status of the inventory registry, and to flag any discrepancies in the inventory information. In particular, inventory validation module 138 may include a master inventory that can be compared to the inventory information from inventory registry 124 to validate the contents of the inventory registry. If there are any discrepancies between inventory registry 124 and the master inventory, then an indication of the discrepancies can be provided to the user or administrator of inventory system 100, as needed or desired. In a particular case, an initial iteration of the collection of the inventory information can be provided to inventory validation module 128 for use as the master inventory against which subsequent inventory collections can be measured. When the user or administrator receives an indication of discrepancies, the user or administrator can validate the changes, and such changes can be incorporated into the master inventory. A method for validation the inventory information as described herein is further shown in FIG. 4, below.

The differentiation between the functions and features of cloud-based applications 120 and back-end inventory manager 130 are provided for the purposes of illustration, and are not meant to describe a particular architecture. As such, some or all of the functions and features of cloud-based applications 120 may be provided by a back-end network service, and likewise some or all of the functions and features of back-end inventory manager 130 may be provided in a the devices of a cloud-based network, as needed or desired.

FIG. 2 illustrates a method 200 for providing a declarative instantaneous inventory collection on an inventory network starting at block 202. An inventory manager receives an inventory specification in block 204, and a number of nodes in a cluster defined by the inventory specification is determined in block 206. An inventory object for the inventory specification is created in block 208. The inventory object triggers the reconciliation of the inventory specification and the collection of the inventory information in block 210. The inventory information is collected in an inventory registry and the inventory registry is published in block 212. The method ends in block 214.

FIG. 3 illustrates a method 300 for processing an instantaneous inventory collection on an inventory network starting at block 302. An inventory specification is registered onto an inventory network in block 304, and the inventory network monitors for a new inventory object or for a change to an existing inventory object in block 306. A decision is made as to whether or not the inventory object was newly created in block 308. If not, the “NO” branch of decision block 308 is taken and the method proceeds to decision block 316 as described below. If the inventory object was newly created, the “YES” branch of decision block 308 is taken, and the inventory object is validated in block 310. After the new inventory object is validated, the inventory process is triggered in block 312, the status of the inventory process is propagated to the inventory network in block 314, and the method ends in block 328.

Returning to decision block 308, when the inventory object is not a newly created inventory object, and the “NO” branch is taken, a decision is made as to whether or not the inventory object has been changed in decision block 316. If not, the “NO” branch of decision block 316 is taken and the method proceeds to decision block 320 as described below. If the inventory object was changed, the “YES” branch of decision block 316 is taken, and the inventory object change is validated in block 318. After the changed inventory object is validated, the inventory process is triggered in block 312, the status of the inventory process is propagated to the inventory network in block 314, and the method ends in block 328.

Returning to decision block 316, when the inventory object has been changed, and the “NO” branch is taken, a decision is made as to whether or not the inventory object has been deleted in decision block 320. If not, the “NO” branch of decision block 320 is taken, the deletion of the inventory object is validated in block 322, and the method ends in block 328. If the inventory object has been deleted, the “YES” branch of decision block 320 is taken, and the inventory object is read in block 326, and the method ends in block 328.

FIG. 4 illustrates a method 400 for validating an inventory of an inventory network starting at block 402. An inventory of inventory items is created in accordance with an inventory object in block 404. The inventory is validated against a prior inventory in block 406. Any discrepancies between the new inventory and the prior inventory are flagged in block 408, and the method ends in block 410.

FIG. 5 illustrates a generalized embodiment of an information handling system 500. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 500 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 500 can include processing resources for executing machine-executable code, such as a central processing unit (CPU), a programmable logic array (PLA), an embedded device such as a System-on-a-Chip (SoC), or other control logic hardware. Information handling system 500 can also include one or more computer-readable medium for storing machine-executable code, such as software or data. Additional components of information handling system 500 can include one or more storage devices that can store machine-executable code, one or more communications ports for communicating with external devices, and various input and output (I/O) devices, such as a keyboard, a mouse, and a video display. Information handling system 500 can also include one or more buses operable to transmit information between the various hardware components.

Information handling system 500 can include devices or modules that embody one or more of the devices or modules described below, and operates to perform one or more of the methods described below. Information handling system 500 includes a processors 502 and 504, an input/output (I/O) interface 510, memories 520 and 525, a graphics interface 530, a basic input and output system/universal extensible firmware interface (BIOS/UEFI) module 540, a disk controller 550, a hard disk drive (HDD) 554, an optical disk drive (ODD) 556, a disk emulator 560 connected to an external solid state drive (SSD) 564, an I/O bridge 570, one or more add-on resources 574, a trusted platform module (TPM) 576, a network interface 580, a management device 590, and a power supply 595. Processors 502 and 504, I/O interface 510, memory 520, graphics interface 530, BIOS/UEFI module 540, disk controller 550, HDD 554, ODD 556, disk emulator 560, SSD 564, I/O bridge 570, add-on resources 574, TPM 576, and network interface 580 operate together to provide a host environment of information handling system 500 that operates to provide the data processing functionality of the information handling system. The host environment operates to execute machine-executable code, including platform BIOS/UEFI code, device firmware, operating system code, applications, programs, and the like, to perform the data processing tasks associated with information handling system 500.

In the host environment, processor 502 is connected to I/O interface 510 via processor interface 506, and processor 504 is connected to the I/O interface via processor interface 508. Memory 520 is connected to processor 502 via a memory interface 522. Memory 525 is connected to processor 504 via a memory interface 527. Graphics interface 530 is connected to I/O interface 510 via a graphics interface 532, and provides a video display output 536 to a video display 534. In a particular embodiment, information handling system 500 includes separate memories that are dedicated to each of processors 502 and 504 via separate memory interfaces. An example of memories 520 and 525 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 540, disk controller 550, and I/O bridge 570 are connected to I/O interface 510 via an I/O channel 512. An example of I/O channel 512 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 510 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/UEFI module 540 includes BIOS/UEFI code operable to detect resources within information handling system 500, to provide drivers for the resources, initialize the resources, and access the resources. BIOS/UEFI module 540 includes code that operates to detect resources within information handling system 500, to provide drivers for the resources, to initialize the resources, and to access the resources.

Disk controller 550 includes a disk interface 552 that connects the disk controller to HDD 554, to ODD 556, and to disk emulator 560. An example of disk interface 552 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 560 permits SSD 564 to be connected to information handling system 500 via an external interface 562. An example of external interface 562 includes a USB interface, an IEEE 2394 (Firewire) interface, a proprietary interface, or a combination thereof. Alternatively, solid-state drive 564 can be disposed within information handling system 500.

I/O bridge 570 includes a peripheral interface 572 that connects the I/O bridge to add-on resource 574, to TPM 576, and to network interface 580. Peripheral interface 572 can be the same type of interface as I/O channel 512, or can be a different type of interface. As such, I/O bridge 570 extends the capacity of I/O channel 512 when peripheral interface 572 and the I/O channel are of the same type, and the I/O bridge translates information from a format suitable to the I/O channel to a format suitable to the peripheral channel 572 when they are of a different type. Add-on resource 574 can include a data storage system, an additional graphics interface, a network interface card (NIC), a sound/video processing card, another add-on resource, or a combination thereof. Add-on resource 574 can be on a main circuit board, on separate circuit board or add-in card disposed within information handling system 500, a device that is external to the information handling system, or a combination thereof.

Network interface 580 represents a NIC disposed within information handling system 500, on a main circuit board of the information handling system, integrated onto another component such as I/O interface 510, in another suitable location, or a combination thereof. Network interface device 580 includes network channels 582 and 584 that provide interfaces to devices that are external to information handling system 500. In a particular embodiment, network channels 582 and 584 are of a different type than peripheral channel 572 and network interface 580 translates information from a format suitable to the peripheral channel to a format suitable to external devices. An example of network channels 582 and 584 includes InfiniBand channels, Fibre Channel channels, Gigabit Ethernet channels, proprietary channel architectures, or a combination thereof. Network channels 582 and 584 can be connected to external network resources (not illustrated). The network resource can include another information handling system, a data storage system, another network, a grid management system, another suitable resource, or a combination thereof.

Management device 590 represents one or more processing devices, such as a dedicated baseboard management controller (BMC) System-on-a-Chip (SoC) device, one or more associated memory devices, one or more network interface devices, a complex programmable logic device (CPLD), and the like, that operate together to provide the management environment for information handling system 500. In particular, management device 590 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 500, such as system cooling fans and power supplies. Management device 590 can include a network connection to an external management system, and the management device can communicate with the management system to report status information for information handling system 500, to receive BIOS/UEFI or system firmware updates, or to perform other task for managing and controlling the operation of information handling system 500. Management device 590 can operate off of a separate power plane from the components of the host environment so that the management device receives power to manage information handling system 500 when the information handling system is otherwise shut down. An example of management device 590 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 590 may further include associated memory devices, logic devices, security devices, or the like, as needed or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A system comprising:
a plurality of information handling systems, each information handling system including a plurality of inventory items; and
an inventory manager configured to manage an inventory object, and to collect an inventory of the inventory items based on the inventory object, wherein the inventory object identifies inventory information related to the inventory items that are to be collected in the inventory, and identifies execution information related to the collection of the inventory.

2. The system of claim 1, wherein the inventor manager is further configured to provide an inventory specification that provides a template for the inventory object.

3. The system of claim 2, wherein the inventory specification provides for the selection of the inventory information to be collected in the inventory.

4. The system of claim 3, wherein the inventory information includes at least one of the information handling systems, hardware associated with the information handling systems, firmware instantiated on the information handling systems, software loaded on the information handling systems, and virtual machines instantiated on the information handling systems.

5. The system of claim 2, wherein the inventory specification provides for the selection of the execution information for the inventory.

6. The system of claim 5, wherein the execution information includes at least one of a frequency of collection of the inventory, a trigger condition for the collection of the inventory, and a time of collection of the inventory.

7. The system of claim 1, wherein the inventory manager is further configured to validate the inventory after the inventory is collected.

8. The system of claim 7, wherein the inventory is validated against a master inventory.

9. The system of claim 1, further comprising a cloud network including an inventory collector to collect the inventory from the information handling systems and an inventory registry to store the inventory.

10. The system of claim 1, wherein the information handling systems include at least one of a computer, a datacenter device, and an Internet-of-Things device.

11. A method for inventorying items on a plurality of information handling systems, the method comprising:
providing, in an inventory system, the information handling systems; and
managing, by an inventory manager, an inventory object to collect an inventory of the items based on the inventory object, wherein the inventory object identifies inventory information related to the items that are to be collected in the inventory, and identifies execution information related to the collection of the inventory.

12. The method of claim 11, further comprising providing, by the inventory manager, an inventory specification that provides a template for the inventory object.

13. The method of claim 12, wherein the inventory specification provides for the selection of the inventory information to be collected in the inventory.

14. The method of claim 13, wherein the inventory information includes at least one of the information handling systems, hardware associated with the information handling systems, firmware instantiated on the information handling systems, software loaded on the information handling systems, and virtual machines instantiated on the information handling systems.

15. The method of claim 12, wherein the inventory specification provides for the selection of the execution information for the inventory.

16. The method of claim 15, wherein the execution information includes at least one of a frequency of collection of the inventory, a trigger condition for the collection of the inventory, and a time of collection of the inventory.

17. The method of claim 11, further comprising validating, by the inventory manager, the inventory after the inventory is collected.

18. The method of claim 17, wherein the inventory is validated against a master inventory.

19. The method of claim 11, further comprising providing, on the inventory system, a cloud network including an inventory collector to collect the inventory from the information handling systems and an inventory registry to store the inventory.

20. A system for inventorying items on a plurality of information handling systems, the inventory system comprising:
an inventory manager configured to manage an inventory object, and to collect an inventory of the items based on the inventory object, wherein the inventory object identifies inventory information related to the items that are to be collected in the inventory, and identifies execution information related to the collection of the inventory, and wherein the inventory manager is further configured to validate the inventory; and
a cloud network including an inventory collector to collect the inventory from the information handling systems and an inventory registry to store the inventory.
